(19) United States
(12) Patent Application Publication
(10) Pub. No.: US 2019/0108606 A1
(43) Pub. Date: Apr. 11, 2019

(54) INFORMATION PROCESSING SYSTEM, INFORMATION PROCESSING APPARATUS, INFORMATION PROCESSING METHOD, AND PROGRAM

(71) Applicant: NS SOLUTIONS CORPORATION, Tokyo (JP)

(72) Inventor: Masakazu KOMIYAMA, Tokyo (JP)

(21) Appl. No.: 16/082,503

(22) PCT Filed: Jun. 23, 2017
(86) PCT No.: PCT/JP2017/023263

§ 371 Date: Sep. 5, 2018

(30) Foreign Application Priority Data
Jun. 28, 2016 (JP) 2016-127233

(51) Int. Cl. G06Q 50/28; B65G 1/137; H04N 5/445; G06K 7/14; G06K 7/10

(52) U.S. Cl. CPC G06Q 50/28; B65G 1/1371; G06T 7/70; G06K 7/1417; G06K 7/10722; H04N 5/445

(57) ABSTRACT

An information processing system according to the present invention includes: a photographer configured to photograph an image; a first specifier configured to specify, based on markers of a shelf contained in a photographed image photographed by the photographer, the shelf from the photographed image; a second specifier configured to specify, based on markers of articles contained in the photographed image, the articles stored in the shelf from the photographed image; and a memory configured to store information of the shelf specified by the first specifier and information of the articles specified by the second specifier in association with each other.

### TECHNICAL FIELD

The present invention relates to an information processing system, an information processing apparatus, an information processing method, and a program.

### BACKGROUND ART

In terms of the article inventory management in a warehouse, there are a technique in which a label or an RFID tag attached to an article is read by a reader to be managed with storing position information (Patent Literature 1) and a technique of reading association of article information with storing position information of an article by a sensor installed on a shelf (Patent Literature 2).

### CITATION LIST

### Patent Literature

Patent Literature 1: Japanese Patent No. 5904287

Patent Literature 2: Japanese Patent No. 3907915

### SUMMARY OF INVENTION

### Technical Problem

However, in the technique of reading an RFID tag by a reader, work in which a person reads an article placed on a high shelf by using a reader is accompanied by instability. Further, in the technique of reading by a sensor, it is necessary to install a plurality of sensors on a shelf, and not only an installation cost, but also a maintenance cost for maintenance or the like after installation tends to increase. Further, in the case where determination of a storage place of an article when the article is stored in a warehouse is entrusted to workers at a job site, the storage place of the article is not managed in a form in which workers other than the worker in charge of the storing can find the storage place of the article, resulting in that there is a problem that efficient inventory management is not performed.

An object of the present invention is to efficiently perform article inventory management without accompanying unstable work while suppressing a maintenance cost.

### Solution to Problem

An information processing system according to the present invention includes: a photographer configured to photograph an image; a first specifier configured to specify, based on markers of a shelf contained in a photographed image photographed by the photographer, the shelf from the photographed image; a second specifier configured to specify, based on markers of articles contained in the photographed image, the articles stored in the shelf from the photographed image; and a memory configured to store information of the shelf specified by the first specifier and information of the articles specified by the second specifier in association with each other.

### Advantageous Effects of Invention

According to the present invention, it is possible to efficiently perform article inventory management without accompanying unstable work while suppressing a maintenance cost.

### BRIEF DESCRIPTION OF DRAWINGS

FIG. 1 is a view illustrating one example of a configuration of an article management system.

FIG. 2 is a front view of a shelf in a first embodiment.

FIG. 3 is a view illustrating one example of a marker.

FIG. 4 is a diagram illustrating one example of a hardware configuration of an information processing apparatus.

FIG. 5 is a diagram illustrating one example of a hardware configuration of a photographing device.

FIG. 6 is a diagram illustrating one example of a hardware configuration of a display device.

FIG. 7 is a diagram illustrating one example of a software configuration of the information processing apparatus.

FIG. 8 is a diagram illustrating one example of a software configuration of the photographing device.

FIG. 9 is a diagram illustrating one example of a software configuration of the display device.

FIG. 10 is a diagram illustrating one example of a composition of a shelf information table in the first embodiment.

FIG. 11A is a diagram. illustrating one example of a composition of an article storage information table.

FIG. 11B is a diagram illustrating another example of the composition of the article storage information table.

FIG. 12 is a flowchart illustrating one example of article storage information update processing.

FIG. 13 is a view illustrating one example of a photographed image in the first embodiment.

FIG. 14 is a view illustrating one example of a superimposed image.

FIG. 15 is a front view of a shelf in a second embodiment.

FIG. 16 is a diagram illustrating one example of a composition of a shelf information table in the second embodiment.

FIG. 17 is a view illustrating one example of a photographed image in the second embodiment.

### DESCRIPTION OF EMBODIMENTS

Hereinafter, there will be explained embodiments of the present invention based on the drawings.

### First Embodiment

### [Overall Configuration of an Article Management System]

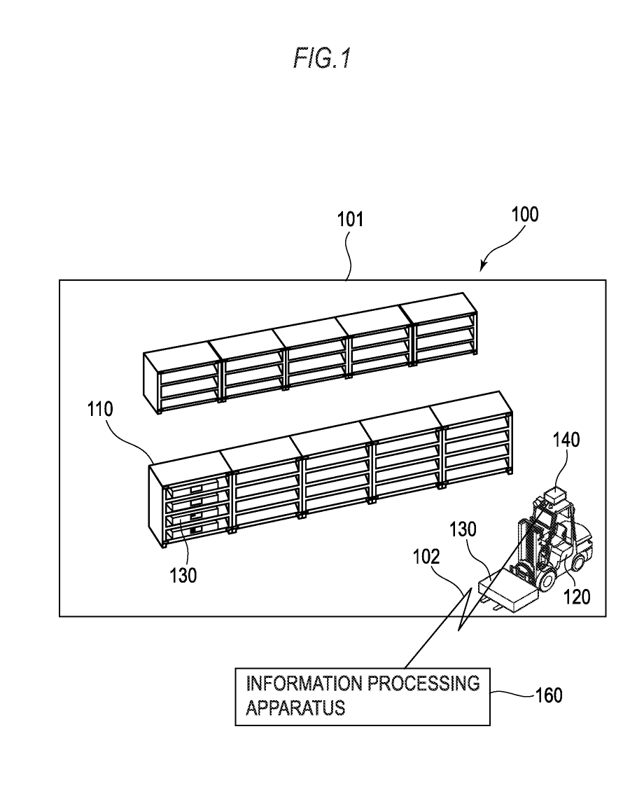

First, there will be explained an overall configuration of an article management system 100 according to a first embodiment with reference to FIG. 1. The article management system 100 is a system that manages articles 130 to be stored in a warehouse 101, and includes: shelves 110; a conveyor 120; a photographing device 140; an information processing apparatus 160; and a display device 180 not illustrated in FIG. 1. The article management system 100 is one example of an information processing system.

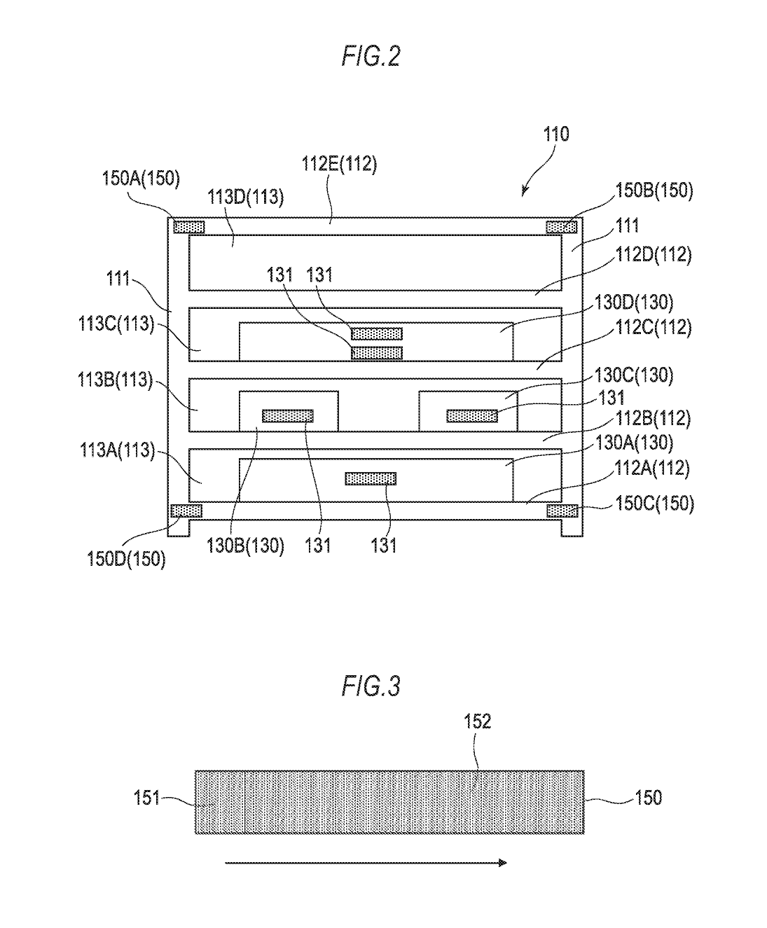

The plural shelves 110 are disposed in the warehouse 101, where the articles 130 can be stored. Here, the shelf 110 will be explained with reference to FIG. 2. FIG. 2 is a front view of the shelf 110. The shelf 110 includes: a pair of sidewalls 111; and a plurality of shelf plates 112. The paired sidewalls 111 are disposed to extend in the vertical direction. Each of the shelf plates 112 is a partition member of the shelf 110, and has end portions thereof bonded to the paired sidewalls 111 so as to make a main surface thereof horizontal. The shelf 110 illustrated in FIG. 2 includes five shelf plates 112, which are a first shelf plate 112A to a fifth shelf plate 112E in order from the bottom. The uppermost fifth shelf plate 112E becomes a top plate of the shelf 110. The four shelf plates 112, which are the first shelf plate 112A to the fourth shelf plate 112D, become a first stage to a fourth stage of the shelf 110 respectively. The region surrounded by the shelf plates 112 and the sidewalls 111 becomes a storage space 113 for the articles 130 at each stage of the shelf 110. For example, a region surrounded by the first shelf plate 112A and the second shelf plate 112B and the paired sidewalls 111 becomes a storage space 113A at the first stage of the shelf 110. Similarly, a storage space 113B at the second stage to a storage space 113D at the fourth stage of the shelf 110 are formed. Incidentally, the number of stages of the shelf 110 is not limited to four, and the shelf 110 may have a first stage to a third stage, or five stages or more.

Markers 150 are attached to the front of the shelf 110. Here, the marker 150 will be explained with reference to FIG. 3. FIG. 3 is a view of the marker 150. The marker 150 is an optical readable type, in which predetermined information is stored. The information contained in the marker 150 can be acquired by analyzing and reading image data obtained by photographing the marker 150. The marker 150 contains a first region 151 and a second region 152. The first region 151 is a region to be a reading start position of the marker 150. The reading start position is a position to be a datum when reading the information from the marker 150, and is defined by a predetermined symbol or color. In the second region 152, the information stored in the marker 150 is stored. The information stored in the marker 150 is read while being analyzed in the order progressing in a direction from the first region 151 to be the reading start position to the second region 152 (the arrow direction in FIG. 3).

The marker 150 is attached to front four corner portions of the shelf 110 as illustrated in FIG. 2. That is, four markers of a first marker 150A to a fourth marker 150D are attached to the shelf 110. Each of the markers 150 is attached to the shelf 110 so as to make the first region 151 come close to the corner portion of the shelf 110 rather than the second region. For the markers 150, for example, a QR code (registered trademark) or color bits (registered trademark) are used, but ones other than these may be used.

In the marker 150 of the shelf 110, a shelf ID being an identifier that identifies the shelf 110 is stored. The shelf ID is an identifier peculiar to each shelf 110.

The articles 130 can be stored on each stage of the shelf 110. In the example of FIG. 2, an article 130A is placed on the first shelf plate 112A being the first stage. On the second shelf plate 112B being the second stage, a second article 130B and a third article 130C are placed side by side horizontally. On the third shelf plate 112C being the third stage, a fourth article 130D and a not-illustrated fifth article are placed at the front and at the back in line. The fifth article is placed at the hack of the fourth article 130D, and thus is not illustrated in FIG. 2.

A marker 131 is attached to each of the articles 130 on the front side of the shelf 110. The marker 131 is formed in the same manner as the marker 150 explained with reference to FIG. 3. In the marker 131 of the article 130, an article ID being an identifier that identifies the article is stored. The article ID is an identifier peculiar to each article 130.

In the article management system 100, it is a general rule that the single marker 131 is to be attached to the articles 130 to be managed as a single group. To each of the first article 130A to the third article 130C, for example, the single marker 131 is attached as illustrated in FIG. 2. However, the case where articles are arranged at the front and at Lhe back in line like the fourth article 130D and the not-illustrated fifth article placed on the third shelf plate 112C is set that the marker 131 of the article 130 arranged at the back is attached to the article 130 placed at the front. Therefore, to the fourth article 130D, the marker 131 of the fourth article 130D and the marker 131 of the fifth article placed at the back are attached. Incidentally, in such a case as a premise that the fourth article and the fifth article are conveyed together, only the single marker 131 obtained after embedding the information of the fifth article placed at the back in the marker 131 of the fourth article 130D may be attached.

Returning to FIG. 1, the explanation of the article management system 100 will be continued.

The conveyor 120 can convey the article 130, and moves in the warehouse 101 to store 130 in the shelf 110 in the warehouse 101 and take the article 130 out of the shelf 110. As the conveyor 120, for example, a forklift is used. A plurality of the conveyors 120 may be disposed in the warehouse 101.

The photographing device 140 can photograph images and transmit a photographed image to the information processing apparatus 160 via a network 102. The photographing device 140 is attached to the conveyor 120 to direct a photographing direction of the photographing device 140 to the front of the conveyor 120. The photographing device 140 continues photographing unless otherwise instructed and continues transmitting a photographed image to the information processing apparatus 160. Incidentally, the network 102 is set to a radio communication network, but may be a wired network.

The information processing apparatus 160 receives the photographed image from the photographing device 140 to analyze it, to thereby update information of a storage place of the article 130. Details of the processing by the information processing apparatus 160 will be described later.

The display device 180 that is not illustrated in FIG. 1 displays a superimposed image generated by the information processing apparatus 160. Incidentally, the superimposed image will be explained later. The display device 180 may be a wearable camera that an operator of the conveyor 120 can wear, or a fixed device that a manager of the article management system 100 refers to.

[Hardware Configuration]

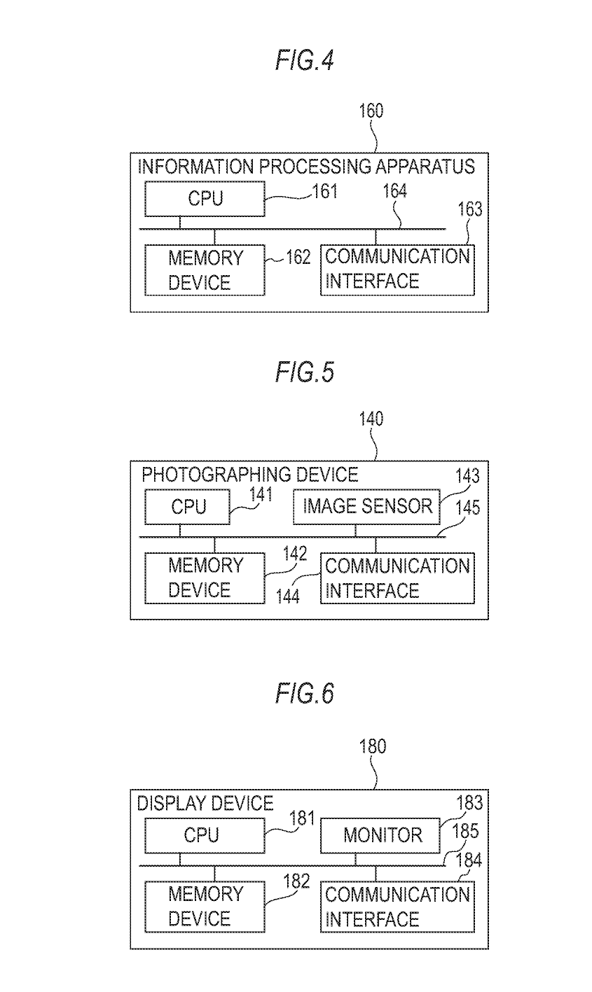

Next, there will be explained a hardware configuration of the information processing apparatus 160 with reference to FIG. 4. FIG. 4 is a hardware configuration diagram of the information processing apparatus 160. The information processing apparatus 160 includes: a CPU 161; a memory device 162; a communication interface 163; and a bus 164 connecting these as hardware.

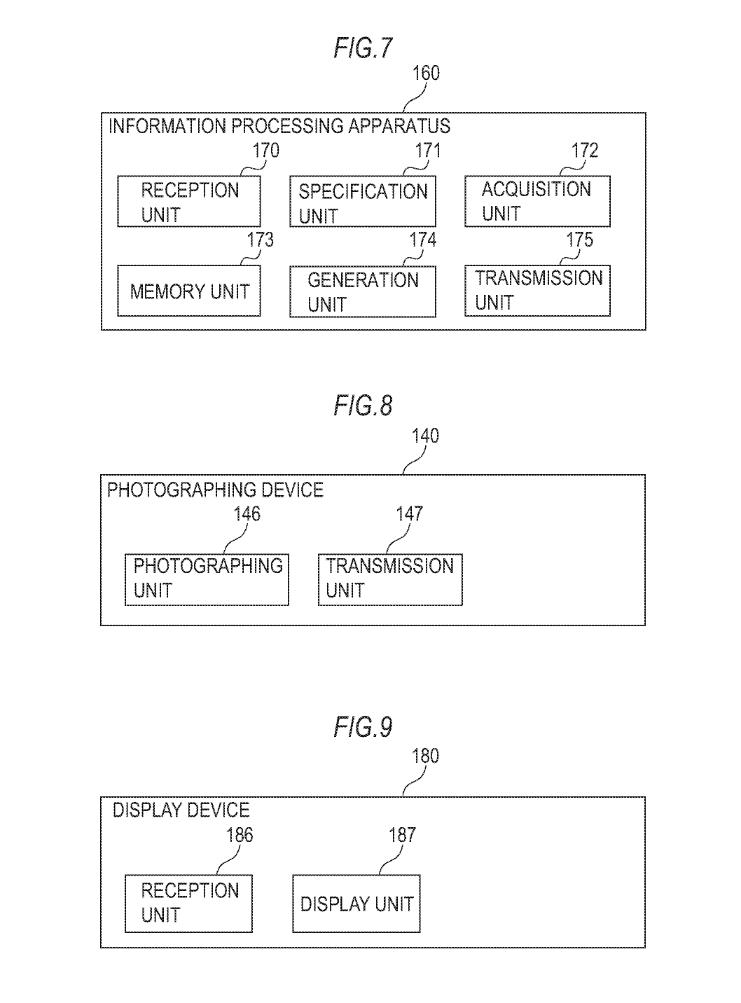

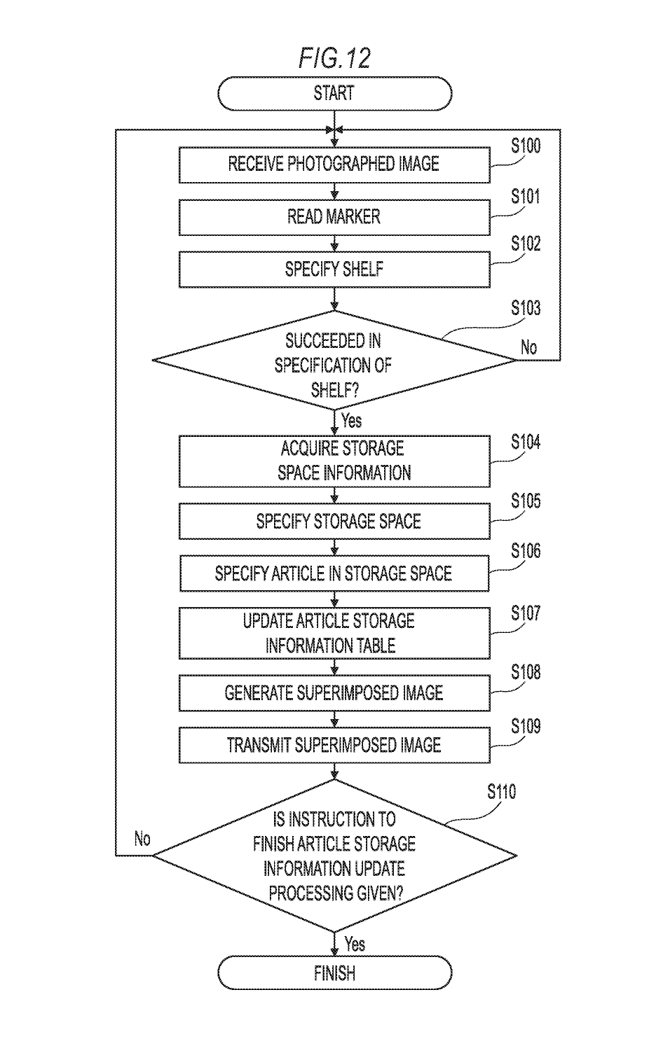

The CPU 161 controls the entire information processing apparatus 160. The CPU 161 executes processing based on programs stored in the memory device 162 or the like, and thereby functions of the information processing apparatus 160 illustrated in FIG. 7 and later-described processing of a flowchart in FIG. 12 are performed.

The memory device 162 is a memory device such as a RAM, a ROM, or a HDD, and stores programs and stores data or the like to be used when the CPU 161 executes processing based on the programs. Further, the memory device 162 stores various tables to be explained later. The memory device 162 is one example of a storage medium that stores programs.

The communication interface 163 manages controls of communication between the information processing apparatus 160 and an external device such as the photographing device 140 or the display device 180.

Next, there will be explained a hardware configuration of the photographing device 140 with reference to FIG. 5. FIG. 5 is a hardware configuration diagram of the photographing device 140. The photographing device 140 includes: a CPU 141; a memory device 142; an image sensor 143; a communication interface 144; and a bus 145 connecting these as hardware.

The CPU 141 controls the entire photographing device 140. The CPU 141 executes processing based on programs stored in the memory device 142 or the like, and thereby functions of the photographing device 140 illustrated in FIG. 8 are performed.

The memory device 142 is a memory device such as a RAM, a ROM, or a HDD, and stores programs and stores data or the like to be used when the CPU 141 executes processing based on the programs.

The image sensor 143 is used when the photographing device 140 photographs, and generates a digital image from light that has passed through a not-illustrated lens.

The communication interface 144 manages controls of communication between the photographing device 140 and an external device such as the information processing apparatus 160.

Next, there will be explained a hardware configuration of the display device 180 with reference to FIG. 6. FIG. 6 is a hardware configuration diagram of the display device 180. The display device 180 includes: a CPU 181; a memory device 182; a monitor 183; a communication interface 184; and a bus 185 connecting these as hardware.

The CPU 181 controls the entire display device 180. The CPU 181 executes processing based on programs stored in the memory device 182 or the like, and thereby functions of the display device 180 illustrated in FIG. 9 are performed.

The memory device 182 is a memory device such as a RAM, a ROM, or a HDD, and stores programs and stores data or the like to be used when the CPU 181 executes processing based on the programs.

The monitor 183 displays an image received by the information processing apparatus 160. As the monitor 183, a liquid crystal monitor or the like is used.

The communication interface 184 manages controls of communication between the display device 180 and an external device such as the information processing apparatus 160.

[Software Configuration]

Next, there will be explained a software configuration of the information processing apparatus 160 with reference to FIG. 7. FIG. 7 is a software configuration diagram of the information processing apparatus 160. The information processing apparatus 160 includes: a reception unit 170; a specification unit 171; an acquisition unit 172; a memory unit 173; a generation unit 174; and a transmission unit 175 as software.

The reception unit 170 receives a photographed image from the photographing device 140 via the communication interface 163.

The specification unit 171 specifies the shelf 110 from the photographed image based on the markers 150 of the shelf 110 contained in the photographed image received by the reception unit 170. Further, the specification unit 171 specifies the storage spaces 113 of the shelf 110 from the photographed image based on the markers 150 of the shelf 110 contained in the photographed image received by the reception unit 170. Further, the specification unit 171 specifies the article 130 stored in the storage space 113 of the shelf 110 from the photographed image based on the marker 131 of the article 130 contained in the photographed image received by the reception unit 170.

The acquisition unit 172 acquires storage space information, which is information of the storage spaces 113, from a later-explained shelf information table.

The memory unit 173 stores information of the shelf 110, information of the storage spaces 113, and information of the articles 130 that are specified by the specification unit ¹⁷¹ in an article storage information table of the memory device 162 in association with one another.

The generation unit 174 generates a superimposed image made by superimposing the information of the shelf 110 and the information of the articles 130 that are specified by the specification unit 171 on the photographed image received by the reception unit 170.

The transmission unit 175 transmits the superimposed image generated by the generation unit 174 to the display device 180 via the communication interface 163.

Next, there will be explained a software configuration of the photographing device 140 with reference to FIG. 8. FIG. 8 is a software configuration diagram of the photographing device 140. The photographing device 140 includes: a photographing unit 146; and a transmission unit 147 as software.

The photographing unit 146 performs photographing using the image sensor 143 or the like to generate a photographed image.

The transmission unit 147 transmits the photographed image generated by the photographing unit 146 to the display device 180 via the communication interface 144.

Next, there will be explained a software configuration of the display device 180 with reference to FIG. 9. FIG. 9 is a software configuration diagram of the display device 180. The display device 180 includes: a reception unit 186; and a display unit 187 as software.

The reception unit 186 receives the superimposed image from the information processing apparatus 160 via the communication interface 184.

The display unit 187 displays the superimposed image received by the reception unit 186 on the monitor 183.

[Data Structure]

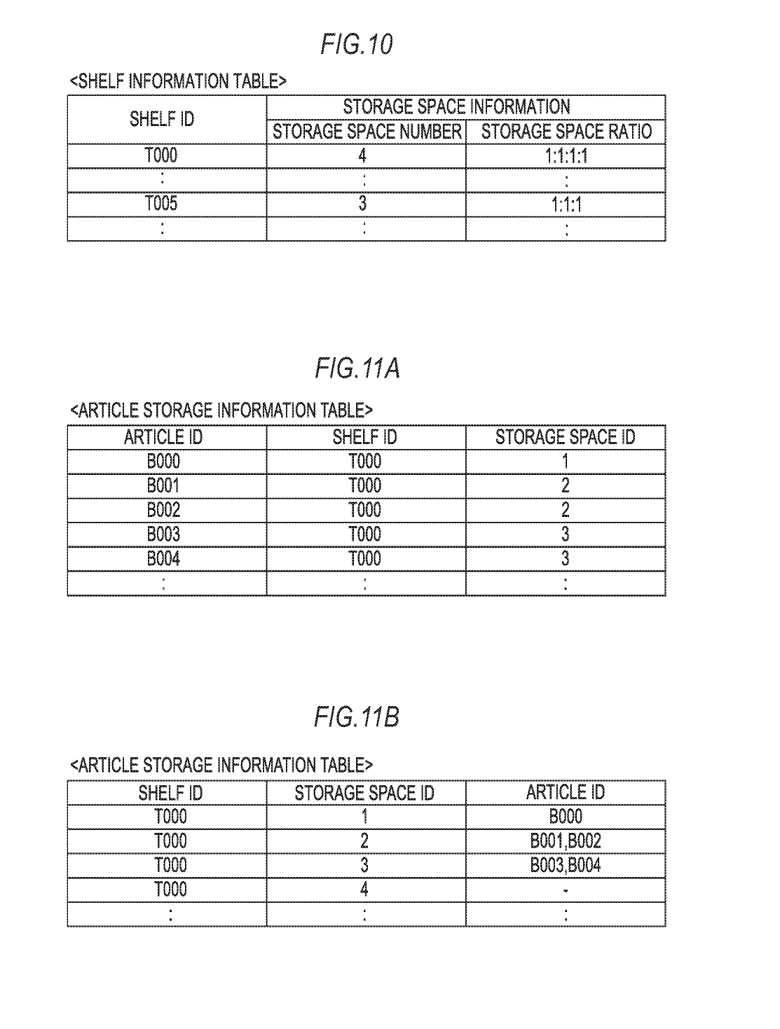

Next, there will be explained the shelf information table with reference to FIG. 10. The shelf information table is a table that stores the shelf ID and the storage space information in association with each other.

The shelf ID is an identifier peculiar to each shelf 110.

The storage space information is information regarding the storage space 113 of the shelf 110, and is composed of a storage space number and a storage space ratio. The storage space number is the number of storage spaces 113 provided in the shelf 110, and is equal to the number of stages of the shelf 110. The storage space ratio is a ratio of lengths in a preset direction of the storage spaces 113 provided in the shelf 110. In this embodiment, the preset direction is set to the longitudinal direction (height direction of the shelf).

For example, as for the shelf 110 with the shelf ID of “T000” in FIG. 10, the storage space number is “4” and the storage space ratio is “1:1:1:1.” This indicates that the number of storage spaces 113 is four and the lengths in the longitudinal direction of the respective storage spaces 113 are the same in ratio like the shelf 110 illustrated in FIG. 2.

Incidentally, the storage space information may contain information of actual lengths in a preset direction of the respective storage spaces, in place of the storage space ratio. In this case, the specification unit 171 calculates the ratio of the lengths in the preset direction of the storage spaces 113 from the actual lengths in the preset direction of the respective storage spaces. The storage space ratio and the actual lengths in the preset direction of the respective storage spaces each are one example of length ratio information. The length ratio information is not limited to the storage space ratio or the actual length in the preset direction of the storage space, but only needs to be information capable of determining the ratio of the lengths in the preset direction of the storage spaces 113 provided in the shelf 110.

Next, there will be explained the article storage information table with reference to FIG. 11A. FIG. 11A is a composition diagram of a first example of the article storage information table. The article storage information table stores the shelf ID being the information of the shelf 110, a storage space ID being the information of the storage spaces 113 provided in the shelf 110, and the article ID being the information of the article 130 stored in the storage space 113 in association with one another. The storage space ID is an identifier that identifies the storage space 113 in each of the shelves 110.

In the article storage information table illustrated in FIG. 11A, the shelf ID and the storage space ID are associated with the article ID based on the article ID as a key.

For example, in the article storage information table illustrated in FIG. 11A, it is indicated that the article 130 with the article ID of “B000” is stored in the storage space 113 with the storage space ID of “1” in the shelf 110 with the shelf ID of “T000.”

The article storage information table is not limited to the composition illustrated in FIG. 11A, but may be a composition illustrated in FIG. 11B, for example. FIG. 11B is a composition diagram of a second example of the article storage information table.

In an article storage information table in FIG. 11B, based on a combination of the shelf ID and the storage space ID as a key, the article ID is associated with the combination of the shelf ID and the storage space ID.

The shelf information table in FIG. 10 and the article storage information table in FIG. 11A or FIG. 11B are stored in the memory device 162 of the information processing apparatus 160. However, a configuration in which the shelf information table and the article storage information table are stored in a memory device other than that in the information processing apparatus 160 illustrated in FIG. 1 may be applied. In this case, the information processing apparatus 160 accesses the memory device other than that in the information processing apparatus 160 via the network to then acquire data from the shelf information table and the article storage information table and update the shelf information table and the article storage information table.

Further, the shelf information table and the article storage information table have been explained as a RDB (relational database) here, but may be fabricated by one other than the RDB such as a KVS (key-value store), for example. Incidentally, the shelf information table and the article storage information table may be fabricated by a transaction-based database or a non-transaction-based database.

[Article Storage Information Update Processing]

Next, there will be explained article storage information update processing with reference to FIG. 12. FIG. 12 is a flowchart of the article storage information update processing. The article storage information update processing is processing to specify, based on the photographed image transmitted to the information processing apparatus 160 from the photographing device 140 attached to the conveyor 120, a storage place of the article 130 and update the article storage information table illustrated in FIG. 11A or FIG. 11B.

In S100, the reception unit 170 receives the photographed image photographed by the photographing device 140 via the network 102.

In S101, the specification unit 171 reads the markers 131, 150 photographed in the photographed image received in S100. The specification unit 171 identifies whether the markers 131 each are the marker 131 of the article 130, in which the article ID has been stored, and whether the markers 150 each are the marker 150 of the shelf 110, in which the shelf ID has been stored, based on the read information. Further, the specification unit 171 handles the positions of the read markers 131, 150 as the position of the first region 151 to be the reading start position of 131, 150.

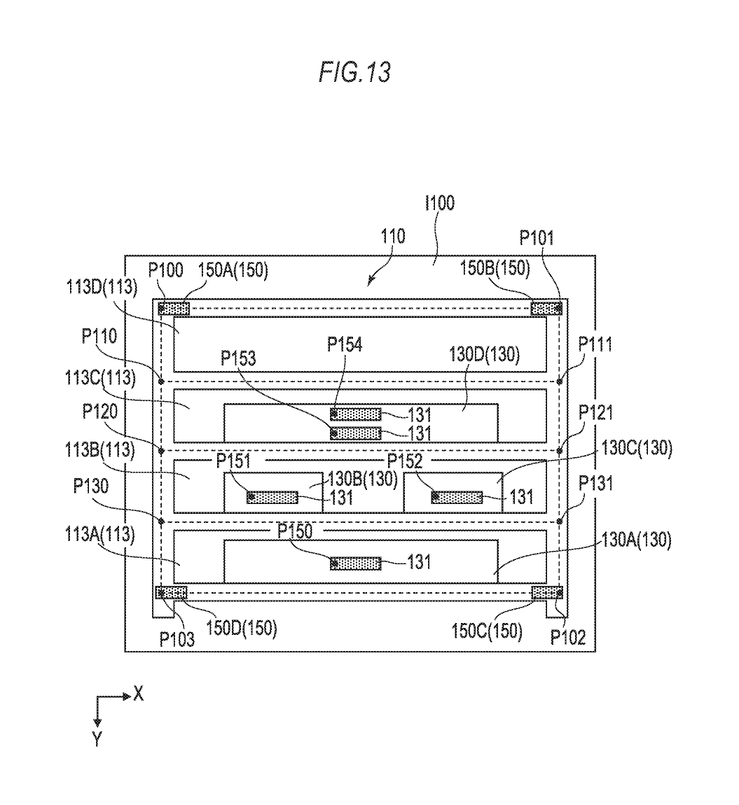

Here, with reference to FIG. 13, there will be explained examples of the markers 131, 150 that are read by the specification unit 171. FIG. 13 is a view illustrating a photographed image I100. The photographed image I100 is an image obtained by photographing the shelf 110 from the front of the shelf 110 illustrated in FIG. 2. In the photographed image I100, nine markers 131, 150 in total are photographed. The specification unit 171 reads these all markers 131, 150. The specification unit 171 reads information of the markers 131, 150 to thereby identify that the four markers 150 displayed at four corner portions of the photographed image I100 each are the marker 150 of the shelf 110 in which the shelf ID has been stored. Further, the specification unit 171 identifies that the five markers 131 displayed at the center portion of the photographed image I100 each are the marker 131 of the article 130 in which the article ID has been stored. Then, the specification unit 171 represents the positions of the markers 131, 150 in the photographed image I100 by the first region 151 to be the reading start position of the markers 131, 150. Incidentally, the first region 151 has a certain degree of area as illustrated in FIG. 3, but for example, the coordinates at the center (barycenter) of each of the photographed first regions 151 are employed as the above-described position. Further, in the case where as the marker 131, there is used a type in which The first region 151 indicating the reading start position is not particularly prepared like a QR code, the coordinates at the center (barycenter) of the entire marker 150 may be employed as the above-described position. As a result, the specification unit 171 sets the positions of the markers 150A to 150D to positions of points P100 to P103 illustrated in FIG. 13, and sets the positions of the five markers 131 to points P150 to P154.

In S102 in FIG. 12, the specification unit 171 specifies the shelf 110 from the read markers 150 of the shelf 110. More specifically, the specification unit 171 specifies, when in the photographed image, there is a pair of markers 150 of the shelf 110 disposed in a direction inclined relative to the vertical direction of an object in the photographed image and the paired markers 150 have the same shelf ID, the shelf 110 with this shelf ID from the photographed image. The specification unit 171 can also specify the plural shelves 110 from the photographed image. Incidentally, the vertical direction of the object in the photographed image may be preset, and based on information obtained when the photographing device 140 photographs, the photographing device 140 may transmit the information of the vertical direction of the photographed image to the information processing apparatus 160 together with the photographed image.

In the example of the photographed image I100 in FIG. 13, the vertical direction of the object is preset to the Y-axis direction being the longitudinal direction of the photographed image I100. Then, in the photographed image I100, the paired markers 150A and 150C of the shelf 110 disposed in a direction obliquely inclined relative to the Y-axis direction are photographed. Further, the markers 150A and 150C are the ones attached to the same shelf 110, and thus each store the same shelf ID. Accordingly, the specification unit 171 specifies the shelf 110 with the shelf ID stored in the marker 150A based on the markers 150A and 150C. Incidentally, the specification unit 171 may specify the shelf 110 based on the markers 150B and 150D. This is because the markers 150B and 150D are also disposed in the direction obliquely inclined relative to the Y-axis direction and each store the same shelf ID.

In S103 in FIG. 12, the specification unit 171 judges whether or not the specification unit 171 has succeeded in specification of the shelf 110 in S102 most recently. When having succeeded in the specification of the shelf 110, the specification unit 171 advances the processing to 5104, and when having failed, the specification unit 171 returns the processing to S100.

In S104, the acquisition unit 172 of the information processing apparatus 160 acquires the storage space information corresponding to the shelf ID from the shelf information table by using the shelf ID of the shelf 110 specified in S102. In the case where there are a plurality of the shelves 110 specified in S102, the acquisition unit 172 acquires the storage space information corresponding to each of the shelf IDs by using the shelf IDs of the respective shelves 110.

In S105, the specification unit 171 specifies the storage space 113 of the shelf 110 from the photographed image based on the markers 150 of the shelf 110 and the storage space information acquired in S104.

At this time, the specification unit 171 first specifies a rectangular region having lines parallel to the vertical direction of the object in the photographed image as its sides with the positions of the paired markers 150 of the shelf 110 used for the specification of the shelf 110 in S102 set to both ends of its diagonal line. The specified rectangular region is a region of the shelf 110 in the photographed image. In the example of the photographed image I100 in FIG. 13, it is set that the markers 150A and 150C are used for the specification of the shelf 110. In this case, as a rectangular region having lines parallel to the vertical direction of the object in the photographed image as its sides with the point P100 indicating the position of the marker 150A and the point P102 indicating the position of the marker 150C set to both ends of its diagonal line, the specification unit 171 specifies a rectangular region with the points P100 to P103 set to its vertexes.

Next, the specification unit 171, based on the storage space information, divides the specified rectangular region into regions to specify each of the divided regions as the storage space 113.

At this time, the specification unit 171 divides the specified rectangular region into a number of regions matching the storage space number of the storage space information. At the same time, the specification unit 171 divides the specified rectangular region in the longitudinal direction so that the ratio of lengths in the longitudinal direction, namely, in the vertical direction of the object in the photographed image becomes equal to the storage space ratio of the storage space information. Then, the specification unit 171 specifies each of the divided regions as the storage space 113. Incidentally, the storage space ID of the storage space 113 is set to increase by one as the storage space 113 goes upward by setting the storage space ID of the lowermost storage space 113 to 1, for example.

In the example of the photographed image I100 in FIG. 13, the storage space number is set to “4” and the storage space ratio is set to “1:1:1:1.” At this time, the specified rectangular region with the points P100 to P103 set as its vertexes is equally divided into four regions in the Y-axis direction being the vertical direction and four storage spaces of a first storage space 113A to a fourth storage space 113D are specified. The first storage space 113A is a rectangular region with points P130 and P131 and the points P102 and P103 set as its vertexes, and its storage space ID is “1.” The second storage space 113B is a rectangular region with points P120 and P121 and the points P130 and P131 set as its vertexes, and its storage space ID is “2.” The third storage space 113C is a rectangular region with points P110 and P111 and the points P120 and P121 set as its vertexes, and its storage space ID is “3.” The fourth storage space 113D is a rectangular region with the points P100, P101, P110, and P111 as its vertexes, and its storage space ID is “4.”

In S106 in FIG. 12, the specification unit 171 specifies the articles 130 stored in the shelf 110 from the photographed image based on the markers 131 of the articles 130. In this embodiment, the specification unit 171 specifies the storage space 113 of the shelf 110, in which the article 130 is stored. More specifically, the specification unit 171 specifies, when the position of the marker 131 of the article 130 in the photographed image, which is read in S101, is contained in the storage space 113 in the photographed image, which is specified in S105, the article 130 as having been stored in this storage space 113. When there is no marker 131 of the article 130 in the storage space 113, the specification unit 171 judges that the article 130 has not been stored in this storage space 113.

In the example of the photographed image I100 in FIG. 13, for example, the point P150 indicating the position of the marker 131 of the first article 130A is contained in the first storage space 113A, and thus the specification unit 171 specifies the first article 130A as the article 130 stored in the first storage space 113A. In the same manner, the points P151 and P152 indicating the positions of the second article 130B and the third article 130C are contained in the second storage space 113B. Thus, the specification unit 171 specifies the second article 130B and the third article 130C as the article 130 stored in the second storage space 113B. In the same manner, the points P153 and P154 indicating the positions of the markers 131 of the fourth article 130D and the fifth article are contained in the third storage space 113C. Thus, the specification unit 171 specifies the fourth article 130D and the fifth article as the article 130 stored in the third storage space 113C. Further, there is no marker 131 of the article 130 in the fourth storage space 113D. Thus, the specification unit 171 judges that the article 130 is not stored in the fourth storage space 113D.

In S107, the memory unit 173 stores the shelf ID, the storage space ID, and the article ID in the article storage information table in association with one another to update the article storage information table. The shelf ID, the storage space ID, and the article ID that are stored here are the shelf ID of the shelf 110, the storage space ID of the storage space 113, and the article ID of the article 130 that are specified in S102, S105, and S106 respectively. Here, the article ID is associated with the storage space ID of the storage space 113 in which the article 130 corresponding to the article ID is stored. The storage space ID is associated with the shelf ID of the shelf 110 containing the storage space 113 corresponding to the storage space ID.

Incidentally, when in the article storage information table, as illustrated in FIG. 11B, the combination of the shelf ID and the storage space ID is the key and it is judged that the article 130 has not been stored in the storage space 113, the memory unit 173 performs the processing as follows. That is, the memory unit 173 deletes the article ID associating with the storage space ID corresponding to the storage space 113 that has been judged that the article 130 has not been stored. Thereby, it is expressed in the article storage information table that the article 130 is not stored in the storage space 113 that has been judged that the article 130 has not been stored.

In S108, the generation unit 174 generates a superimposed image made by superimposing the information of the shelf 110 specified in S102 and the information of the articles 130 specified in S106 on the photographed image received in S100. Details of the superimposed image will be described later.

In S109, the transmission unit 175 transmits the superimposed image generated in S108 to the display device 180. The reception unit 186 of the display device 180 receives the superimposed image, and the display unit 187 of the display device 180 displays the received superimposed image on the monitor 183 of the display device 180.

In S110, the transmission unit 175 judges whether or not an instruction to finish the article storage information update processing illustrated in FIG. 12 is given based on an operation or the like by a manager using a not-illustrated input device. The transmission unit 175 finishes the article storage information update processing when the finish instruction is given, and returns the processing to S100 when the finish instruction is not given.

[Superimposed Image]

Next, the superimposed image will be explained. The superimposed image is an image made by superimposing the information of the shelf 110 specified in S102 and the information of the articles 130 specified in S106 on the photographed image. In this embodiment, the shelf ID is used as the information of the shelf 110, and the article ID is used as the information of the article 130.

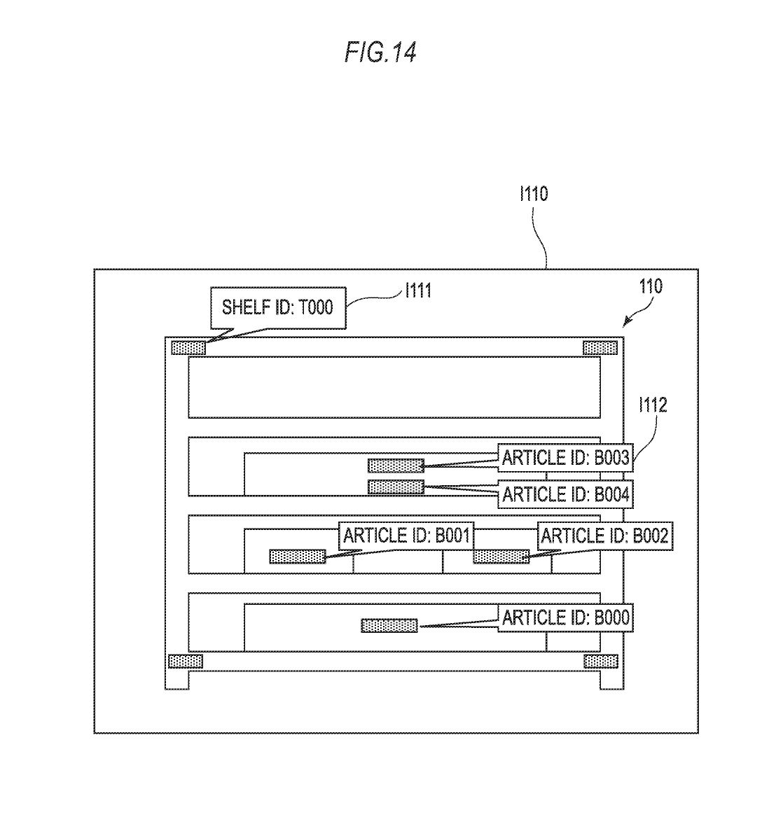

A superimposed image 1110 to be an example of the superimposed image is illustrated in FIG. 14. FIG. 14 is a view illustrating the superimposed image I110. The superimposed image I110 is that an icon I111 where the shelf ID is displayed and icons I112 where the article ID is displayed are superimposed on the photographed image I100 illustrated in FIG. 13. The icons I111, I112 are displayed so as to be able to specify objects represented by the icons I111, I112 respectively.

Incidentally, the superimposed image may be an image made by further superimposing the information of the storage spaces 113 specified in S105 on the photographed image. In this case, for example, the storage space ID may be used as the information of the storage space 113, and similarly to FIG. 14, the storage space ID may be displayed on an icon.

[Effect]

As explained above, the specification unit 171 specifies the shelf 110 from the photographed image based on the markers 150 of the shelf 110 contained in the photographed image photographed by the photographing device 140. Further, the specification unit 171 specifies the articles 130 stored in the shelf 110 from the photographed image based on the markers 131 of the articles 130 contained in the photographed image. Further, the memory unit 173 stores the information of the shelf 110 and the information of the articles 130 that are specified by the specification unit 171 in the memory device 162 in association with each other.

Accordingly, it is possible to suppress the maintenance cost without the need to provide a sensor or the like on the shelf 110. Further, unstable work such that a man uses a reader to read an article placed on a high shelf is not accompanied.

Further, even in the case where storage places of articles in a warehouse are entrusted to workers at a job site, it is possible to specify a storage destination of the article 130 from the photographed image photographed by the photographing device 140, and the memory device 162 stores a specification result. Accordingly, it is possible to objectively manage the storage places of the articles 130.

Further, the information stored in the memory device 162 enables counting of types or an inventory amount of the articles 130 in the warehouse 101, which contributes to efficient inventory management.

Further, the specification unit 171 specifies the shelf 110 from the photographed image based on the markers 150 of the shelf 110 contained in the photographed image photographed by the photographing device 140. Further, the specification unit 171 specifies the articles 130 stored in the shelf 110 from the photographed image based on the markers 131 of the articles 130 contained in the photographed image. Accordingly, it is possible to perform the processing of specifying the shelf 110 and the article 130 by the information processing apparatus 160 at a faster speed.

Further, the photographing device 140 is attached to the conveyor 120. Thus, the photographing device 140 can photograph the state of the shelf 110 after the worker finishes taking in or out of the article 130 by using the conveyor 120. Accordingly, the article management system 100 can always keep the information of the storage places of the articles 130 to a new state based on this photographed image.

Further, the display device 180 displays the superimposed image. Thus, the worker can refer to the information of the articles 130 in the superimposed image displayed on the display device 180 to confirm that the worker himself/herself works correctly and the article management system 100 operates normally.

Further, the markers 150 are attached to the four corner portions on the front of the shelf 110. Each of the markers 150 is attached to the shelf 110 so as to make the first region 151 to be the reading start position of the marker 150 of the shelf 110 come close to the corner portion of the shelf 110 rather than the second region 152 being the other region of the marker of the shelf 110.

Here, the specification unit 171 represents the positions of the markers 150 in the photographed image by the first region 151 of the marker 150. Thus, when the specification unit 171 specifies the region of the shelf 110 in the photographed image from the markers 150, the region does not falsely become a narrow region, resulting in that it is possible to specify a region suitable for the shape of the shelf 110. Accordingly, the accuracy of specification of the article 130 to be stored in the shelf 110 improves.

Further, the acquisition unit 172 acquires the storage space information from the shelf information table. The specification unit 171 specifies the storage space 113 from the photographed image based on the storage space information acquired by the acquisition unit 172. Accordingly, even when the number of stages differs among the shelves 110 or the storage spaces 113 at the respective stages differ in size, the storage space information in the shelf information table is set appropriately, and thereby the specification unit 171 can specify the storage space 113 correctly.

Further, when in the photographed image, there are the paired markers 150 of the shelf 110 that are disposed in a direction inclined relative to the vertical direction of the object in the photographed image, the specification unit 171 specifies the shelf 110 from the photographed image based on the paired markers 150. Accordingly, even when the single marker 150 or the paired markers 150 on the diagonal line are not photographed in the photographed image, the specification unit 171 can specify the shelf 110.

Further, the specification unit 171 specifies, every marker 150 of the shelf 110 that indicates the same shelf 110, the shelf 110 from the photographed image based on the marker 150 of the shelf 110. Accordingly, even when a plurality of the shelves 110 are photographed in the photographed image, it is possible to correctly specify each of the shelves 110.

### Second Embodiment

Next, there will be explained an article management system 100 according to a second embodiment. Here, regarding the article management system 100 according to the second embodiment, explanations of the points similar to those of the article management system 100 according to the first embodiment are omitted and differences will be explained mainly.

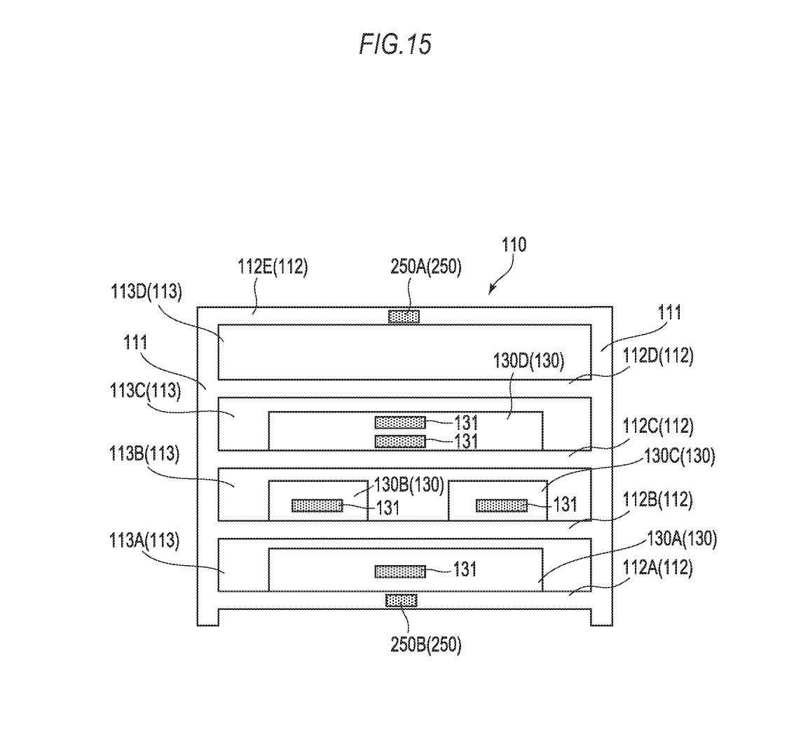

First, there will be explained positions of markers 250 of the shelf 110 in the second embodiment with reference to FIG. 15. FIG. 15 is a front view of the shelf 110 in the second embodiment. The marker 250 itself is formed in the same manner as the marker 150 in the first embodiment explained with reference to FIG. 3. However, in the second embodiment, each one marker 250 is attached to a middle portion in the horizontal direction at an upper portion of the shelf 110 and to a middle portion in the horizontal direction at a lower portion of the shelf 110. In the example in FIG. 15, the single marker 250 is attached to the middle in the horizontal direction on the front side of the shelf plate 112E. Further, the single marker 250 is attached to the middle in the horizontal direction on the front side of the shelf plate 112A.

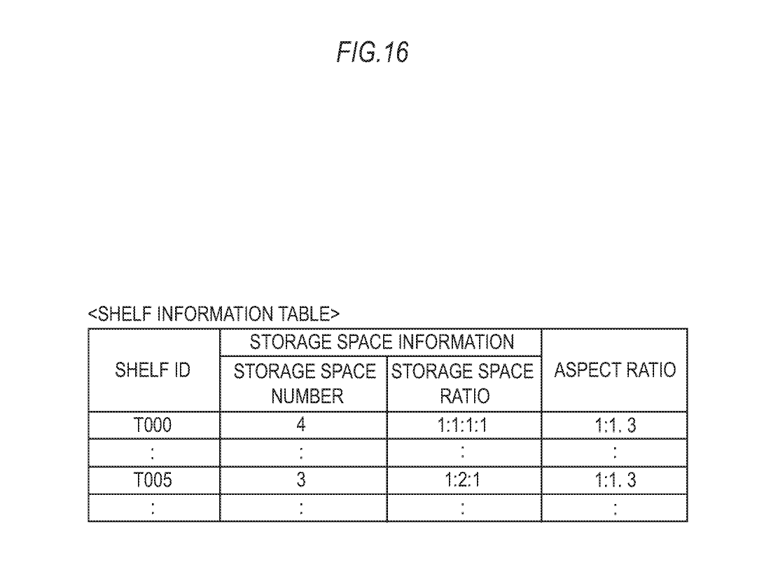

Next, there will be explained a shelf information table in the second embodiment with reference to FIG. 16. FIG. 16 is a composition diagram of the shelf information table in the second embodiment. To the shelf information table in the second embodiment, an aspect ratio is added as compared to the shelf information table in the first embodiment illustrated in FIG. 10. That is, the shelf information table in the second embodiment is a table that stores a shelf ID, storage space information, and an aspect ratio in association with one another.

The aspect ratio indicates a ratio of longitudinal and lateral lengths of the shelf 110. The shelf 110 with the shelf ID of “T000” has an aspect ratio of “1:1.3.” This indicates that the lateral length of the shelf 110 is 1.3 to the longitudinal length of the shelf 110 being 1 when the shelf 110 is viewed from the front.

Incidentally, the shelf information table may contain information of actual longitudinal and lateral lengths of the shelf 110 in place of the aspect ratio. In this case, the specification unit 171 calculates the ratio of the longitudinal and lateral lengths of the shelf 110 from the actual longitudinal and lateral lengths of the shelf 110. The aspect ratio and the actual longitudinal and lateral lengths of the shelf 110 each are one example of longitudinal and lateral ratio information. The longitudinal and lateral ratio information is not limited to the aspect ratio or the actual longitudinal and lateral lengths of the shelf 110, but only needs to be information capable of determining the ratio of the longitudinal and lateral lengths of the shelf 110.

Next, there will be explained article storage information update processing in the second embodiment. In principle, the article storage information update processing is similar to the article storage information update processing in the first embodiment illustrated in FIG. 12, but there are the following differences.

In S102 in the second embodiment, the specification unit 171 specifies the shelf 110 from the read markers 150 of the shelf 110. More specifically, when there are paired markers 150 of the shelf 110 disposed in line in the vertical direction of an object in a photographed image in the photographed image and these paired markers 150 have the same shelf ID, the specification unit 171 specifies the shelf 110 with the shelf ID from the photographed image. The specification unit 171 can also specify the plural shelves 110 from the photographed image.

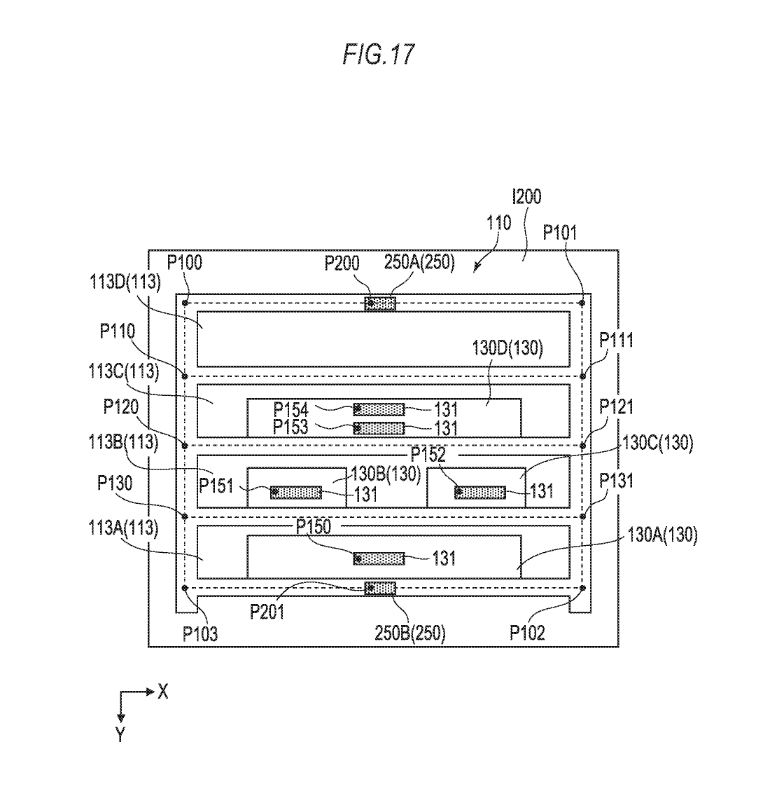

In the example of a photographed image I200 in FIG. 17, the vertical direction of the object is preset to the Y-axis direction being the longitudinal direction of the photographed image I100. Then, there are paired markers 250A and 250B of the shelf 110 that are disposed in line in the Y axis direction. Further, the markers 250A and 250B are attached to the same shelf 110, and thus store the same shelf ID. Accordingly, the specification unit 171 specifies the shelf 110 with the shelf ID stored by the markers 250A and 250B based on the markers 250A and 250B.

In S104 in the second embodiment, the acquisition unit 172 acquires the aspect ratio together with the storage space information corresponding to the shelf ID from the shelf information table by using the shelf ID of the shelf 110 specified in S102.

In S105 in the second embodiment, the specification unit 171 specifies the storage spaces 113 of the shelf 110 from the photographed image based on the markers 250 of the shelf 110 and the storage space information and the aspect ratio that are acquired in S104.

At this time, the specification unit 171 first obtains the longitudinal length of the shelf 110 in the photographed image. This is equal to the distance between the paired markers 150 of the shelf 110 that are used for the specification of the shelf 110.

Next, the specification unit 171 obtains the lateral length of the shelf 110 in the photographed image from the longitudinal length of the shelf 110 in the photographed image and the aspect ratio acquired in S104.

Next, the specification unit 171 specifies a rectangular region such that midpoints of a pair of facing sides become the paired markers 250 and a pair of sides becomes parallel to the vertical direction of the object in the photographed image I100. The lateral length of this specified rectangular region is set to be equal to the lateral length of the shelf 110 in the photographed image obtained in the preceding processing.

In the example of the photographed image I200 in FIG. 17, by using the paired markers 250A, B of the shelf 110, the specification unit 171 specifies a rectangular region with points P100 to P103 set to its vertexes by the processing explained here. Incidentally, the specification unit 171 uses P200 and P201 as the points indicating the markers 250A and 250B.

Next, the specification unit 171 divides the specified rectangular region into regions based on the storage space information, to then specify each of the divided regions as the storage space 113. This processing is similar to the processing in the first embodiment.

In the example of the photographed image I200 in

FIG. 17, the storage space number is set to “4” and the storage space ratio is set to “1:1:1:1.” At this time, similarly to the case of the first embodiment, the first storage space 113A to the fourth storage space 113D are specified.

The other processing of the article storage information update processing in the second embodiment is similar to that in the first embodiment.

As above, also in the second embodiment, the maintenance cost is suppressed and unstable work is not accompanied similarly to the first embodiment. Further, even in the case where determination of storage places of articles in a warehouse is entrusted to workers at a job site, it is possible to specify a storage destination of the article 130 from the photographed image photographed by the photographing device 140. Then, the memory device 162 stores a specification result. Accordingly, it is possible to objectively manage the storage places of the articles 130. Further, the information stored in the memory device 162 enables counting of types or an inventory amount of the articles 130 in the warehouse 101, which contributes to efficient inventory management.

Incidentally, each one of the markers 250 in the second embodiment may be attached to the middle portion in the vertical direction at the left of the shelf 110 and to the middle portion in the vertical direction at the right of the shelf 110. That i each one of the markers 250 may be attached to the middle in the vertical direction on the front side of the paired sidewalls 111 illustrated in FIG. 15. At this time, when there are the paired markers 150 of the shelf 110 disposed in the horizontal direction of the object in the photographed image, the specification unit 171 specifies the shelf 110 based on these paired markers 150. Further, the specification unit 171 can specify a rectangular region by the processing similar to that in S105 in the second embodiment, and further specify the storage spaces 113.

### Third Embodiment

Next, there will be explained an article management system 100 according to a third embodiment. The article management system 100 according to the third embodiment performs the following first presenting processing and second presenting processing in addition to the processings of the article management systems 100 according to the above-described embodiments.

The first presenting processing is processing to present, when a worker takes the article 130 out of the warehouse 101, the storage place of the article 130 to be taken out of the warehouse 101 to the worker or the like.

The second presenting processing is processing to present, when a worker takes the article 130 into the warehouse 101, the storage place of the article 130 to be taken into the warehouse 101 to the worker or the like.

First, there will be explained the first presenting processing.

The specification unit 171 acquires the article ID of the article 130 to be taken out of the warehouse 101 from a not-illustrated input device of the information processing apparatus 160 or an external device via the network 102.

Next, the specification unit 171 searches the article storage information table using the acquired article ID, and acquires the shelf ID and the storage space ID as information of the storage space 113 of the shelf 110 in which the article 130 corresponding to the article ID has been stored. In this manner, the specification unit 171 specifies the shelf 110 and the storage space 113 in which the article 130 has been stored.

Next, the transmission unit 175 of the information processing apparatus 160 transmits the shelf ID and the storage space ID that are acquired by the specification unit 171 to the display device 180.

The reception unit 186 of the display device 180 receives the shelf ID and the storage space ID from the information processing apparatus 160.

The display unit 187 of the display device 180 displays the shelf ID and the storage space ID that are received by the reception unit 186 on the monitor 183 as the storage place of the article 130 to be taken out of the warehouse 101.

In this manner, the article management system 100 presents the storage place of the article 130 to be taken out of the warehouse 101 to the worker or the manager.

Next, there will be explained the second presenting processing.

The specification unit 171 searches the article storage information table to acquire the shelf ID and the storage space ID of the storage space 113 in which the article 130 has not been stored. In this manner, the specification unit 171 specifies the shelf 110 and the storage space 113 to be the storage place of the article 130 to be taken into the warehouse 101.

Incidentally, in the article management system 100, the articles 130 may be classified into groups beforehand according to the type or the like of the article 130. In this case, the specification unit 171 may specify the storage space 113 of the shelf 110, which is close to the storage place of the articles 130 in a group to which the article 130 to be taken into the warehouse 101 belongs and in which the article 130 has not been stored, as the storage place of the article 130. For example, the specification unit 171 specifies the storage space 113 of the shelf 110, which is the shelf 110 in which the articles 130 in a group to which the article 130 to be taken into the warehouse 101 belongs are stored and that has the storage space 113 in which the article 130 has not been stored, as the storage place of the article 130.

Next, the transmission unit 175 of the information processing apparatus 160 transmits the shelf ID and the storage space ID that are acquired by the specification unit 171 to the display device 180.

The reception unit 186 of the display device 180 receives the shelf ID and the storage space ID from the information processing apparatus 160.

The display unit 187 of the display device 180 displays the shelf ID and the storage space ID that are received by the reception unit 186 on the monitor 183 as the storage place of the article 130 to be taken into the warehouse 101.

In this manner, the article management system 100 presents the storage place of the article 130 to be taken into the warehouse 101 to the worker or the manager.

As above, according to the article management system 100 according to the third embodiment, it is possible to present the storage place of the article 130 to be taken out of the warehouse 101 to the worker or the manager from the article storage information table to be updated by the article storage information update processing. Further, it is possible to present the storage place of the article 130 to be taken into the warehouse 101 to the worker or the manager. Accordingly, efficient management of the articles 130 in the warehouse 101 is enabled.

### Another Embodiment

The above-described article management systems 100 each include the display device 180, but do not need to include the display device 180. At this time, the information processing apparatus 160 does not need to generate or transmit a superimposed image.

Further, the above-described markers 131, 150, and 250 are the ones to be attached to the shelf 110 and the article 130, but may be ones to be directly printed on the shelf 110 and the article 130.

Further, in the above-described article management systems 100, the specification unit 171 continues specification until specification of the storage space 113 of the shelf 110 in which the article 130 is to be stored. However, the specification unit 171 may stop specification after specifying the shelf 110 in which the article 130 is to be stored. Thereby, the specification unit 171 does not need to specify the storage space 113, resulting in that speeding up of the processing is achieved. Further, in this case, the shelf information table is not needed, and the storage space IDs in the article storage information table are not needed. Accordingly, it is possible to reduce a memory capacity of the memory device 162.

In the foregoing, the preferred embodiments of the present invention have been described in detail, but the present invention should not be limited to the specific embodiments and various alternation and modification are possible within a range of the scope of the present invention that is disclosed in the claims. For example, the above-described embodiments may be combined arbitrarily and implemented.

Incidentally, the photographing device 140, the information processing apparatus 160, and the display device 180 each are one example of a computer.

1.-19. (canceled)

20. A system, comprising:
a photographing device configured to photograph an image;
a first specifier configured to specify, based on markers of a shelf contained in a photographed image photographed by the photographing device, the shelf from the photographed image;
a second specifier configured to specify, based on markers of articles contained in the photographed image, the articles stored in the shelf from the photographed image; and
a memory configured to store information of the shelf specified by the first specifier and information of the articles specified by the second specifier, the shelf specified by the first specifier and the articles specified by the second specifier from the same photographed image, in association with each other, wherein
the photographing device is attached to a conveyor which conveys the article.

21. A system, comprising:
a photographing device configured to photograph an image;
a first specifier configured to specify, based on markers of a shelf contained in a photographed image photographed by the photographing device, the shelf from the photographed image;
a second specifier configured to specify, based on markers of articles contained in the photographed image, the articles stored in the shelf from the photographed image;
a memory configured to store information of the shelf specified by the first specifier and information of the articles specified by the second specifier, the shelf specified by the first specifier and the articles specified by the second specifier from the same photographed image, in association with each other; and
a displayer configured to display a superimposed image made by superimposing information of the shelf specified by the first specifier and information of the articles specified by the second specifier on the photographed image.

22. A system, comprising:
a photographing device configured to photograph an image;
a first specifier configured to specify, based on markers of a shelf contained in a photographed image photographed by the photographing device, the shelf from the photographed image;
a second specifier configured to specify, based on markers of articles contained in the photographed image, the articles stored in the shelf from the photographed image;
a memory configured to store information of the shelf specified by the first specifier and information of the articles specified by the second specifier, the shelf specified by the first specifier and the articles specified by the second specifier from the same photographed image, in association with each other; and
the shelf in which the article is able to be stored and which has markers at four corner portions on a front thereof, wherein
the markers of the shelf each have a reading start position, and
each of the markers of the shelf is attached to the shelf to make a region of the marker of the shelf, which becomes the reading start position of the marker of the shelf, come close to the corner portion on the front of the shelf rather than the other region of the marker of the shelf.

23. An information processing apparatus, comprising:
a first specifier configured to specify, based on markers of a shelf contained in a photographed image photographed by a photographing device, the shelf from the photographed image;
a second specifier configured to specify, based on markers of articles contained in the photographed image, the articles stored in the shelf from the photographed image;
a memory configured to store information of the shelf specified by the first specifier and information of the articles specified by the second specifier, the shelf specified by the first specifier and the articles specified by the second specifier from the same photographed image, in association with each other; and
a third specifier configured to specify storage spaces which are partitioned by partition members of the shelf from the photographed image based on markers of the shelf, wherein
the second specifier specifies the articles stored in the storage space of the shelf from the photographed image based on the markers of the articles contained in the photographed image, and
the memory stores information of the shelf specified by the first specifier, information of the storage spaces of the shelf, the storage spaces specified by the third specifier, and information of the article stored in the storage space, the article specified by the second specifier, in association with one another.

24. The information processing apparatus according to claim 23, further comprising:
an acquirer configured to acquire storage space information being information of the storage spaces, wherein
the third specifier specifies the storage spaces from the photographed image based on markers of the shelf and the storage space information.

25. The information processing apparatus according to claim 24, wherein
the first specifier specifies, when in the photographed image, there is a pair of markers of the shelf which is disposed in a direction inclined relative to a vertical direction of an object in the photographed image, the shelf from the photographed image based on the pair of the markers of the shelf, and
the third specifier specifies the storage spaces from the photographed image based on a rectangular region with the pair of the markers of the shelf set to both ends of a diagonal line thereof and the storage space information.

26. The information processing apparatus according to claim 25, wherein
the storage space information contains length ratio information, and
the third specifier specifies respective regions, the respective regions resulting from dividing the rectangular region in the photographed image in a set direction at a ratio of lengths based on the length ratio information, as the storage spaces.

27. The information processing apparatus according to claim 24, wherein
the first specifier specifies, when there is a pair of markers of the shelf which is disposed in a vertical direction or a horizontal direction of an object in the photographed image, the shelf based on the pair of the markers of the shelf, and
the third specifier specifies the storage spaces based on a rectangular region with midpoints of a pair of facing sides thereof set to the pair of the markers of the shelf and the storage space information.

28. The information processing apparatus according to claim 27, wherein
the storage space information contains longitudinal and lateral ratio information and length ratio information, and
the third specifier specifies the rectangular region from the pair of the markers of the shelf and a ratio of longitudinal and lateral lengths of the shelf based on the longitudinal and lateral ratio information, and specifies respective regions, the respective regions resulting from dividing the rectangular region at a ratio of lengths based on the length ratio information as the storage spaces.

29. An information processing apparatus, comprising:
a first specifier configured to specify, based on markers of a shelf contained in a photographed image photographed by a photographing device, the shelf from the photographed image;
a second specifier configured to specify, based on markers of articles contained in the photographed image, the articles stored in the shelf from the photographed image; and
a memory configured to store information of the shelf specified by the first specifier and information of the articles specified by the second specifier, the shelf specified by the first specifier and the articles specified by the second specifier from the same photographed image, in association with each other, wherein
the first specifier specifies, every marker of the shelf which indicates the same shelf, the shelf from the photographed image based on the marker of the shelf.

30. An information processing apparatus, comprising:
a first specifier configured to specify, based on markers of a shelf contained in a photographed image photographed by a photographing device, the shelf from the photographed image;
a second specifier configured to specify, based on markers of articles contained in the photographed image, the articles stored in the shelf from the photographed image;
a memory configured to store information of the shelf specified by the first specifier and information of the articles specified by the second specifier, the shelf specified by the first specifier and the articles specified by the second specifier from the same photographed image, in association with each other; and
a generator configured to generate a superimposed image made by superimposing information of the shelf specified by the first specifier and information of the articles specified by the second specifier on the photographed image.

31. An information processing apparatus, comprising:
a first specifier configured to specify, based on markers of a shelf contained in a photographed image photographed by a photographing device, the shelf from the photographed image;
a second specifier configured to specify, based on markers of articles contained in the photographed image, the articles stored in the shelf from the photographed image;
a memory configured to store information of the shelf specified by the first specifier and information of the articles specified by the second specifier, the shelf specified by the first specifier and the articles specified by the second specifier from the same photographed image, in association with each other; and
a fifth specifier configured to specify the shelf in which the article is able to be stored based on information stored by the memory.

32. The information processing apparatus according to claim 23, further comprising:
a receiver configured to receive the photographed image.

33. The information processing apparatus according to claim 23, further comprising:
a fourth specifier configured to specify the shelf in which the article is stored based on information of the article and information stored by the memory.

34. An information processing method executed by a system, the information processing method comprising:
a photographing step configured to photograph an image;
a first specification step configured to specify, based on markers of a shelf contained in a photographed image photographed by the photographing step, the shelf from the p hotographed image;
a second specification step configured to specify, based on markers of articles contained in the photographed image, the articles stored in the shelf from the photographed image;
a memory step configured to store information of the shelf specified by the first specification step and information of the articles specified by the second specification step, the shelf specified by the first specification step and the articles specified by the second specification step from the same photographed image, in association with each other; and
a displaying step configured to display a superimposed image made by superimposing information of the shelf specified by the first specification step and information of the articles specified by the second specification step on the photographed image.

35. An information processing method executed by an information processing apparatus, the information processing method comprising:
a first specification step configured to specify, based on markers of a shelf contained in a photographed image photographed by a photographing device, the shelf from the photographed image;
a second specification step configured to specify, based on markers of articles contained in the photographed image, the articles stored in the shelf from the photographed image;
a memory step configured to store information of the shelf specified by the first specification step and information of the articles specified by the second specification step, the shelf specified by the first specification step and the articles specified by the second specification step from the same photographed image, in association with each other; and
a third specification step configured to specify storage spaces which are partitioned by partition members of the shelf from the photographed image based on markers of the shelf, wherein
the second specification step is configured to specify the articles stored in the storage space of the shelf from the photographed image based on the markers of the articles contained in the photographed image, and
the memory step is configured to store information of the shelf specified by the first specification step, information of the storage spaces of the shelf, the storage spaces specified by the third specification step, and information of the article stored in the storage space, the article specified by the second specification step, in association with one another.

36. An information processing method executed by an information processing apparatus, the information processing method comprising:
a first specification step configured to specify, based on markers of a shelf contained in a photographed image photographed by a photographing device, the shelf from the photographed image;
a second specification step configured to specify, based on markers of articles contained in the photographed image, the articles stored in the shelf from the photographed image; and
a memory step configured to store information of the shelf specified by the first specification step and information of the articles specified by the second speclication step, the shelf specified by the first specification step and the articles specified by the second specification step from the same photographed image, in association with each other, wherein
the first specification step is configured to specify, every marker of the shelf which indicates the same shelf, the shelf from the photographed image based on the marker of the shelf.

37. An information processing method executed by an information processing apparatus, the information processing method comprising:
a first specification step configured to specify, based on markers of a shelf contained in a photographed image photographed by a photographing device, the shelf from the photographed image;
a second specification step configured to specify, based on markers of articles contained in the photographed image, the articles stored in the shelf from the photographed image;
a memory step configured to store information of the shelf specified by the first specification step and information of the articles specified by the second specification step, the shelf specified by the first specification step and the articles specified by the second specification step from the same photographed image, in association with each other; and
a generation step configured to generate a superimposed image made by superimposing information of the shelf specified by the first specification step and information of the articles specified by the second specification step on the photographed image.

38. An information processing method executed by an information processing apparatus, the information processing method comprising:
a first specification step configured to specify, based on markers of a shelf contained in a photographed image photographed by a photographing device, the shelf from the photographed image;
a second specification step configured to specify, based on markers of articles contained in the photographed image, the articles stored in the shelf from the photographed image;
a memory step configured to store information of the shelf specified by the first specification step and information of the articles specified by the second specification step, the shelf specified by the first specification step and the articles specified by the second specification step from the same photographed image, in association with each other; and
a fifth specification step configured to specify the shelf in which the article is able to be stored based on information stored by the memory step.

39. A program product for causing a computer to function as respective components of the information processing apparatus according to claim 35.
